(19) United States
(12) Patent Application Publication
(10) Pub. No.: US 2014/0142775 A1
(43) Pub. Date: May 22, 2014

(54) Power production systems with a safety and reliability monitoring system and methods for improving safety and reliability for power production systems

(71) Applicant: Kenneth Scott, Sunnyvale, CA (US)

(72) Inventor: Kenneth Scott, Sunnyvale, CA (US)

(73) Assignee: Eco Power Design LLC, Sunnyvale, CA (US)

(21) Appl. No.: 13/987,674

(22) Filed: Aug. 21, 2013

Related U.S. Application Data
(60) Provisional application No. 61/743,382, filed on Sep. 4, 2012.

(51) Int. Cl. H02H 3/05; G05B 9/02

(52) U.S. Cl. CPC H02H 3/05; G05B 9/02
USPC 700/292

(57) ABSTRACT

The present invention provides a system and method for monitoring or controlling a small to medium solar or wind power production system to provide improved safety and reliability of the system, wherein the monitoring or control system provides one or more of firmware, hardware, software logic, or monitoring circuits in a system designed to increase its safety or to improve its reliability that includes: a circuit combined with one or more of hardware or software logic that provide a means for monitoring said power production system to check for over load or under load measurements at a plurality of power switches of said power production system.

### TECHNICAL FIELD

The field of the present invention relates to solar or wind power production systems that are small to medium in size, which include or are associated with at least one safety and reliability monitoring system. The invention also includes the field of methods for improving safety and reliability of small to medium solar or wind power productions systems that utilize one or more of firmware, hardware, software logic, or monitoring circuits in a system to increase safety or to improve the reliability of these small to medium power production systems.

### BACKGROUND ART

Solar power generation systems or small wind power generation systems, along with their power inverters, control systems and safety features can cost 10's of thousands of dollars even for a single residence. These power generation systems and inverters need to be reliable enough to handle faults and failures in order to provide steady reliable power to their owner or manager that assures a reliability lifespan of 10 years or more. Complex power supply systems can fault or fail in ways that can result in expensive damage to the system, fire, electrical shock, or very inconvenient power outages. Also, such faults and failures can occur in ways causing sufficient damage to the system to make it very difficult to find root causes for those faults or failures.

Small to medium solar or wind power generation systems can be stand-alone systems or can be connected to a power utility company system through converters where surplus power is sold to the utility company. For system power level reliability, in either type of power generation system there needs to be a back-up power supply in case of faults or failures. Short term low power generation levels are fairly easy to detect and readily remedied by supplying backup power as pass through power that is stored locally or is obtained from the utility company. However, system faults can cause longer term power generation failures that would exhaust stored power for stand alone systems, or defeat one of the main purposes for a power generation system, which is to avoid high payments for power purchase from utilities.

To increase reliability of their systems many power system installation firms submit their completed systems to an agency check upon completion, and perhaps from time to time during a warranty or maintenance contract period. This is a major step taken to help guarantee safety and reliability of the power generation system.

A system safety features agency check may include installing and checking the working order of one or more of fuses, surge protectors, spacing of components, proper insulation, and systems for keeping equipment temperatures low.

However the safety agency check is only done on a limited number of samples of the equipment and usually only looks for immediate fire and shock hazards. Failures can still occur within the power production system that results in severe enough damage to make root cause failure analysis difficult. Resulting inability to identify a root cause for failure can delay or eliminate improvements that could be made to the equipment to improve reliability.

Reliability improvements can also be achieved by good circuit design, redundancy and using suitably de-rated high quality components. Unfortunately however carefully attempts are made to make systems more reliable through these improvements system weaknesses can still occur that can result in severe failure of the power systems.

There is a need for newer devices to have longer warranty periods and to be more reliable to justify the longer warranty periods. For example, solar inverters need to have 10 years or longer warranty for solar power generation systems, and inverters may be built into the house's design or wiring architecture that requires even longer warranty periods.

Another problem with solar or small wind power inverters is that mandatory shut down may be required by local government building codes if the power line voltage or frequency inside a building goes outside relatively tight limits. Exceeding such limits may be caused by one or more of faulty power generation units, faulty power generation wiring, an inverter fault or problem, or wiring within the building. Consumers may blame the inverter manufacturer for these drop outs that could raise liability issues for the inverter manufacturer or system installer when the problem may be faulty power generation units or faulty wiring, or may be simply a problem within the building wiring. Monitoring systems are needed to identify faulty power generation units of problems with faulty power generation wiring and to inform power production consumers that they need to contact the electrical power production supplier to fix the power generation system issue when an inverter is functioning properly and no internal housing wiring problem exists, in that the issue is located within the power generation system itself or within power generation power line wiring.

As solar or wind power generation systems become more commonly in use for buildings, it is essential that power production lines or faulty units be repaired or replaced as soon as possible to minimize the possibility of large quantities of faulty units or similar problems building up sufficiently to result in a large fault or failure without much warning.

Accordingly, there are needed improved or additional systems and methods to protect solar or wind power generation systems against sudden and unexpected failures and faults by early identification and reporting of system problems to the consumer or to the agency that monitors the system for the consumer.

### BRIEF SUMMARY OF THE INVENTION

In one embodiment, the present invention provides a monitoring or control system for improving safety and reliability of small to medium solar or wind power productions systems wherein said monitoring or control system provides one or more of firmware, hardware, software logic, or monitoring circuits in a system to increase safety or to improve the reliability of said small to medium power production system comprising:

(a) a circuit combined with one or more of hardware or software logic that provide a means for monitoring said power production system to check for over load or under load measurements at a plurality of power switches of said power production system,

(b) a circuit combined with one or more of hardware or software logic that provides a means for monitoring said power production system and output power stream circuits to determine if power line voltage or frequency goes outside of preset limits,

(c) a circuit combined with one or more of hardware or software logic that provides a means for recording, reporting or both if one or more of an over load, under load, power line voltage abnormality or power frequency abnormality are detected,

(d) a circuit combined with one or more of hardware or software logic that provides a means to place all monitored circuitry that can be overloaded or under-loaded in a safe mode, and

(e) a circuit combined with one or more of hardware or software logic to receive a report of the occurrence of an over load, under load, power line voltage abnormality or power frequency abnormality within the power production system or associated circuits and to place all or part of the monitored circuitry in a safe mode.

In a preferred embodiment, the present invention provides said monitoring or control system as described above wherein the safe mode system means comprises one or more of the following:

(a) a circuit combined with one or more of hardware or software logic to shut down all or a portion of the power converter or power output system until input power can be removed and reapplied,

(b) a circuit combined with one or more of hardware or software logic to shut down all or a portion of the power converter or power output system and provide a timed retry of power input or output at a low enough duty cycle as not to damage the power devices,

(c) a circuit combined with one or more of hardware or software logic to shut down all or a portion of the power converter or power output system and provide operation of the system at a reduced stress level by reducing system load, and

(d) a circuit combined with one or more of hardware or software logic to shut down all or a portion of the power converter or power output system and engaging a stress reducing circuit that is built into the power production system.

In another embodiment, the critical power device stress monitoring circuits may comprises:

(i) a monitoring circuit and analysis logic that monitors for too high or too low a stress that could indicate incorrect operation of the circuit,

(ii) a circuit, logic or system to put the system in safe mode if a parameter being monitored is too high or too low, wherein the safe state options may include one or more of the following: (a) shutting down all or a portion of the system until input power can be removed and reapplied, (b) shutting down all or a portion of the system followed by timed retry to run at low enough of a duty cycle as to not damage the power devices, (c) lowering down the power of the system to so it runs at a reduced stress level, and (d) other appropriate stress reducing procedures to reduce stress on components that are available as a result of the type of circuit used.

In still another embodiment, the system further comprises logic and hardware that connects to a communications network, such as the interne or other wireless communication systems to automatically send monitored data to a design center or system monitoring center so diagnostics and improvements to the system can be made at soon as possible.

In a further embodiment, the system comprises logic and hardware to provide extra monitoring capability used to monitor operations of the system that may prove useful for root cause analysis. An example of such monitoring would be monitoring the operation of any supervisory circuit or voltage of input power that could help with root cause analysis to diagnose faults and failures.

In a further preferred embodiment said monitoring system further comprises means for recording a time and date that can be logged with any failures to assist with diagnosis of reasons for faults and failures.

### BRIEF DESCRIPTION OF THE DRAWINGS

FIG. 1 is a two stage power circuit that shows an embodiment of the invention.

### DETAILED DESCRIPTION OF THE INVENTION

In one embodiment, the present invention provides a monitoring or control system for improving safety and reliability of small to medium solar or wind power productions systems wherein said monitoring or control system provides one or more of firmware, hardware, software logic, or monitoring circuits in a system to increase safety or to improve the reliability of said small to medium power production system comprising:

(a) a circuit combined with one or more of hardware or software logic that provide a means for monitoring said power production system to check for over load or under load measurements at a plurality of power switches of said power production system,

(b) a circuit combined with one or more of hardware or software logic that provides a means for monitoring said power production system and output power stream circuits to determine if power line voltage or frequency goes outside of preset limits,

(c) a circuit combined with one or more of hardware or software logic that provides a means for recording, reporting or both if one or more of an over load, under load, power line voltage abnormality or power frequency abnormality are detected,

(d) a circuit combined with one or more of hardware or software logic that provides a means to place all monitored circuitry that can be overloaded or under-loaded in a safe mode, and

(e) a circuit combined with one or more of hardware or software logic to receive a report of the occurrence of an over load, under load, power line voltage abnormality or power frequency abnormality within the power production system or associated circuits and to place all or part of the monitored circuitry in a safe mode.

In a preferred embodiment, the present invention provides said monitoring or control system as described above wherein the safe mode system means comprises one or more of the following:

(a) a circuit combined with one or more of hardware or software logic to shut down all or a portion of the power converter or power output system until input power can be removed and reapplied,

(b) a circuit combined with one or more of hardware or software logic to shut down all or a portion of the power converter or power output system and provide a timed retry of power input or output at a low enough duty cycle as not to damage the power devices,

(c) a circuit combined with one or more of hardware or software logic to shut down all or a portion of the power converter or power output system and provide operation of the system at a reduced stress level by reducing system load, and

(d) a circuit combined with one or more of hardware or software logic to shut down all or a portion of the power converter or power output system and engaging a stress reducing circuit that is built into the power production system.

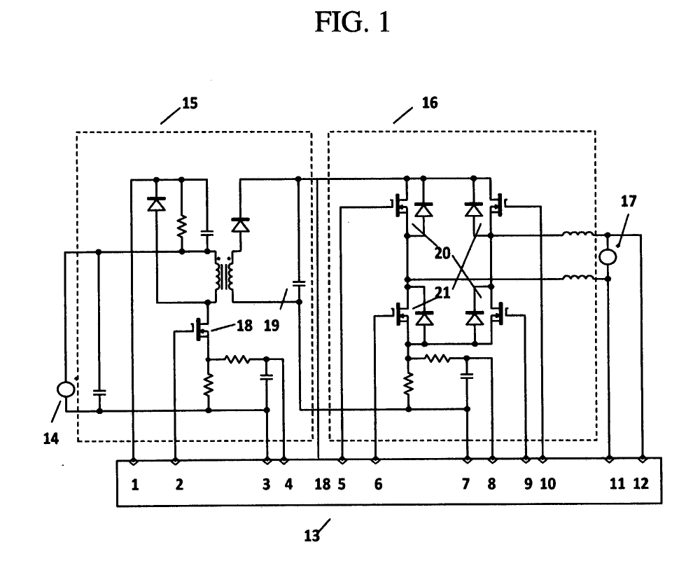

FIG. 1 shows a typical two stage power supply. Item 15 is a DC/DC converter. Item 16 is an inverter. The system is powered from DC source 14. This could be a solar panel. The converter 15 steps up this DC voltage and feeds it to the inverter 16. This inverter feeds the grid supply 17. Item 13 is the controller. The preferred embodiment of this is a microcontroller with essential interface circuits.

Inverter timing is very critical to the stress applied to the inverter fets. Both the inverter voltage, frequency and phase must be accurate.

The following procedure gives an example of how to minimize stress by sequencing turn on of the circuit.

Initially all fets are turned off. When source 17 is connected to the inverter, capacitor 19 will be charged up to the full peak voltage of source 17 by the diodes in fets 20 and 21. To minimize turn on stress of fets 21 source voltage 17 should be monitored and at peak voltage fets 21 should be turned on. Capacitor voltage will then be discharged to near zero when source voltage 17 goes to zero. Fets 21 can then be turned off followed by fets 20 being turned on. Fets 20 will allow capacitor 19 to fully charge then fully discharge. At this period fets 20 will be turned off followed by fets 21 being turned on. The cycle of fets 20 followed by fets 21 being on can then repeat indefinitely.

Once inverter 16 is running converter 15 can be started. Minimum stress will occur if converter is started when C19 is at minimum voltage.

Minimum system turn off stress will occur if turnoff of all fets occurs when C 19 is at minimum voltage.

Item 8 monitors fet 20 and 21 current. During turn on of the inverter, item 8 also measures the capacitor 19 current. This current will be directly proportional to the rate of change of source voltage 17. A typical monitor test would be to check the capacitor 19 current is correct by using item 8 current monitor. If the current is too high or too low the inverter can be put in a safe state by turning off the inverter for a long time followed by turning the inverter back on. If the fault reoccurs the inverter will be quickly turned off again. This cycle can be repeated indefinitely or terminated after a few cycles. A permanent fault would be logged by controller 13.

Item 1 monitors peak fet 18 voltage. If this becomes too high controller 13 can put the system into a safe mode and log the fault.

Item 18 monitors the fet voltages 20 and 21. Any abnormally high voltage can be used to put the fets into a safe state and the fault logged.

When the circuit is running normally item 4 and item 8 will monitor the fet currents. Abnormally high currents would cause controller 13 to put the fets into a suitable safe mode. The fault would be logged into non volatile memory inside controller 13. If a clock function was present the time and date of the fault would also be logged.

If interne capabilities were present fault data could be monitored remotely and product improvements could be started before problem units were returned to the factory for repair and diagnosis. This would allow for rapid improvement of product line quality.

In another preferred embodiment, critical power device stress monitoring circuits may comprises:
(i) a monitoring circuit and analysis logic that monitors for too high or too low a stress that could indicate incorrect operation of the circuit,
(ii) a circuit, logic or system to put the system in safe mode if a parameter being monitored is too high or too low, wherein the safe state options may include one or more of the following: (a) shutting down all or a portion of the system until input power can be removed and reapplied, (b) shutting down all or a portion of the system followed by timed retry to run at low enough of a duty cycle as to not damage the power devices, (c) lowering down the power of the system to so it runs at a reduced stress level, and (d) other appropriate stress reducing procedures to reduce stress on components that are available as a result of the type of circuit used.

In one embodiment, the present invention provides a system and method for improving safety and reliability of small to medium solar or wind power productions systems that utilize one or more of firmware, hardware, software logic, or monitoring circuits in a system to increase safety or to improve the reliability of these small to medium power production systems comprising one or more of the following:
power device inhibit lines,
power quality monitoring systems or methods within both the power generation input side and power output side with recording and reporting of measurements that are outside of specified limits,
critical power device stress monitoring circuits,
logging or otherwise recording faults into non-volatile memory for current or later analysis or diagnosis, and
optionally accessing a communication network such as the internet so faults and measurements can be communicated remotely to be read, analysis, diagnosed or repair initiated to make early improvements or repairs to the production systems before the problems multiply or cause other problems.

In another embodiment, the system further comprises logic and hardware that connects to a communications network, such as the interne or other wireless communication systems to automatically send monitored data to a design center or system monitoring center so diagnostics and improvements to the system can be made at soon as possible.

In a further embodiment, the system comprises logic and hardware to provide extra monitoring capability used to monitor operations of the system that may prove useful for root cause analysis. An example of such monitoring would be monitoring the operation of any supervisory circuit or voltage of input power that could help with root cause analysis to diagnose faults and failures.

In a further preferred embodiment said monitoring system further comprises means for recording a time and date that can be logged with any failures to assist with diagnosis of reasons for faults and failures.

Other aspects and advantages of the present invention will become apparent from the following detailed description, taken in conjunction with the accompanying drawings, illustrated by way of example of the principles of the invention. The scope of the invention is to be defined by the claims appended hereto and their equivalents.

What is claimed is:

1. A monitoring or control system for improving safety and reliability of a small to medium solar or wind power production system having one or more of firmware, hardware, software logic, or monitoring circuits in said system to increase safety or to improve the reliability of said system comprising:
(a) a circuit and one or more of hardware or software logic that together provide a means for monitoring said power production system to check for over load or under load measurements at a plurality of power switches of said power production system,
(b) a circuit and one or more of hardware or software logic that together provide a means for monitoring said power production system and output power stream circuits to determine if power line voltage or frequency goes outside of preset limits,
(c) a circuit and with one or more of hardware or software logic that together provide a means for recording, reporting or both recording and reporting if one or more of an over load, under load, power line voltage abnormality or power frequency abnormality are detected,
(d) a circuit combined with one or more of hardware or software logic that provides a means to place one or more of said monitored circuitry that can be overloaded or under-loaded in a safe mode, and
(e) a circuit combined with one or more of hardware or software logic to receive a report of the occurrence of an over load, under load, power line voltage abnormality or power frequency abnormality within the power production system or associated circuits and to place all or part of the monitored circuitry in a safe mode.

2. The system according to claim 1, wherein said system is a monitoring system.

3. The system according to claim 1, wherein said system is a control system.

4. The system according to claim 1, wherein said system is both a monitoring system and a control system.

5. A system according to claim 1, comprising at least one means to place one or more monitored circuits in a safe mode wherein:
(i) a circuit combined with one or more of hardware logic or software logic to shut down all or a portion of a power converter or a power output system until input power can be removed and reapplied to said power converter or power output system,
(ii) a circuit combined with one or more of hardware logic or software logic to shut down all or a portion of the power converter or power output system and to provide a timed retry of power input or output at a low enough duty cycle to avoid damage to the power devices,
(iii) a circuit combined with one or more of hardware logic or software logic to shut down all or a portion of the power converter or power output system and to provide operation of the system at a reduced stress level by reducing all or a part of said system's power load, and
(iv) a circuit combined with one or more of hardware or software logic to shut down all or a portion of the power converter or of a power output system and to engage a stress reducing circuit that is built into the power production system.

6. A system according to claim 1, comprising at least one critical power device stress monitoring circuit wherein said monitoring circuit further comprises:
(a) a monitoring circuit and analysis logic that monitors parameters for too high or too low a stress as compared to preset stress level settings that could indicate incorrect operation of the circuit, and
(b) a circuit, logic or system providing at least one means to put all or a portion of the system in safe mode if a parameter being monitored indicates too high or too low a stress as compared to preset stress level settings, wherein safe state options for such a safe mode operation may include one or more of the following: (a) shutting down all or a portion of the system until input power can be removed and reapplied, (b) shutting down all or a portion of the system followed by timed retry to run at a sufficiently low duty cycle to avoid damaging power devices that said mode is designed to protect, (c) lowering down the power of the system to provide running the system at a reduced stress level, and (d) implement other preset stress reducing procedures that are build into said system to reduce stress on one or more of said system components wherein said stress reducing procedures are available as a result of the type of circuit being utilized.

7. The system according to claim 1, wherein said system further comprises logic and hardware that connects to a communications network, such as to the internet or to other wireless communication systems with build in functionality to automatically send monitored data to a system design center or to a system monitoring center so diagnostics, repairs or improvements to the system can be made at soon as possible.

8. The system according to claim 1, wherein said system further comprises logic and hardware that provides further monitoring capability that may be utilized to monitor operations of the system that relate to root cause analysis regarding faults.

9. The system according to claim 8, wherein said system provides a means for monitoring the operation of any supervisory circuit or monitoring voltage of an input power circuit that could help to provide root cause analysis when a machine or person is diagnosing or repairing faults and failures.

10. The system according to claim 1, wherein said monitoring or control system further comprises a means for recording a time and date that can be logged with any failures to assist with diagnosis of reasons for faults and failures or recording a time and date when a safe mode, restart or repair is implemented.

11. A method for monitoring or controlling small to medium solar or wind power production system to improve its safety and reliability wherein said monitoring or controlling system is a system according to claim 1.

12. The method according to claim 11, wherein said system is a monitoring system.

13. The method according to claim 11, wherein said system is a control system.

14. The method according to claim 11, wherein said system is both a monitoring system and a control system.

15. The method of claim 11, wherein said system for said method comprises at least one means to place one or more monitored circuits in a safe mode wherein:
(i) a circuit combined with one or more of hardware logic or software logic to shut down all or a portion of a power converter or a power output system until input power can be removed and reapplied to said power converter or power output system,
(ii) a circuit combined with one or more of hardware logic or software logic to shut down all or a portion of the power converter or power output system and to provide a timed retry of power input or output at a low enough duty cycle to avoid damage to the power devices,
(iii) a circuit combined with one or more of hardware logic or software logic to shut down all or a portion of the power converter or power output system and to provide operation of the system at a reduced stress level by reducing all or a part of said system's power load, and
(iv) a circuit combined with one or more of hardware or software logic to shut down all or a portion of the power converter or of a power output system and to engage a stress reducing circuit that is built into the power production system.

16. The method according to claim 11, wherein said method comprises a system with at least one critical power device stress monitoring circuit wherein said monitoring circuit further comprises:
(a) a monitoring circuit and analysis logic that monitors parameters for too high or too low a stress as compared to preset stress level settings that could indicate incorrect operation of the circuit, and
(b) a circuit, logic or system providing at least one means to put all or a portion of the system in safe mode if a parameter being monitored indicates too high or too low a stress as compared to preset stress level settings, wherein safe state options for such a safe mode operation may include one or more of the following: (a) shutting down all or a portion of the system until input power can be removed and reapplied, (b) shutting down all or a portion of the system followed by timed retry to run at a sufficiently low duty cycle to avoid damaging power devices that said mode is designed to protect, (c) lowering down the power of the system to provide running the system at a reduced stress level, and (d) implement other preset stress reducing procedures that are build into said system to reduce stress on one or more of said system components wherein said stress reducing procedures are available as a result of the type of circuit being utilized.

17. The method of claim 11, wherein said system for said method further comprises logic and hardware that connects to a communications network, such as to the interne or to other wireless communication systems with build in functionality to automatically send monitored data to a system design center or to a system monitoring center so diagnostics, repairs or improvements to the system can be made at soon as possible.

18. The method of claim 11, wherein said system of said method further comprises logic and hardware that provides further monitoring capability that may be utilized to monitor operations of the system that relate to root cause analysis regarding faults.

19. The method of claim 18, wherein said system of said method provides a means for monitoring the operation of any supervisory circuit or monitoring voltage of an input power circuit that could help to provide root cause analysis when a machine or person is diagnosing or repairing faults and failures.

20. The method of claim 11, wherein said monitoring or control system of said method further comprises a means for recording a time and date that can be logged with any failures to assist with diagnosis of reasons for faults and failures or recording a time and date when a safe mode, restart or repair is implemented.
